(19) United States
(12) Patent Application Publication
(10) Pub. No.: US 2014/0368701 A1
(43) Pub. Date: Dec. 18, 2014

(54) CLONING IMAGE DATA PATCH IN HOLE OF PIXEL ARRAY (PATCH AND CLONE)

(71) Applicant: Lilong SHI, Pasadena, CA (US)

(72) Inventor: Lilong SHI, Pasadena, CA (US)

(21) Appl. No.: 14/017,271

(22) Filed: Sep. 3, 2013

Related U.S. Application Data
(60) Provisional application No. 61/834,360, filed on Jun. 12, 2013.

(51) Int. Cl. H04N 5/367

(52) U.S. Cl. CPC H04N 5/367
USPC 348/246

(57) ABSTRACT

An imaging device includes a pixel array with a hole within its pixels, and an image signal processor configured to process data generated by the pixels. In a process hereby called “Patch-Clone”, holes in image data are repaired for the eventually rendered image. More particularly, a patch of the pixels can be selected on the basis of how well the data of pixels surrounding the patch match data of pixels surrounding the hole. Then the data of the patch can be cloned, and become rendered instead of the missing data of the hole.

### CROSS REFERENCE TO RELATED PATENT APPLICATIONS

This patent application claims priority from U.S. Provisional Patent Application Ser. No. 61/834,360, filed on Jun. 12, 2013, titled: “A NEW TYPE OF RGBZ SENSOR AND ITS RECONSTRUCTION BY PATCH-CLONE”, the disclosure of which is hereby incorporated by reference for all purposes.

### BACKGROUND

Modern imaging devices use electronic arrays to capture images. The arrays have pixels that generate electric charges, such as electrons, when they are exposed to light from an image. The generated charges of each pixel are stored and then read out as data. The data renders the image.

In some instances there are, effectively speaking, holes in the arrays. A hole is a place in the array that does not contribute image data, where data could be expected. One example is where a pixel's performance deteriorates with time. Another example is where, within a color pixel array, depth detection (“Z”) pixels are provided within the color pixels, for capturing depth information concurrently with color data. Typically such arrays have a specially designed color pattern frequently derived from a standard Bayer, where 8 pixels in a 4×2 neighborhood are replicated by two Z pixels, which capture depth information but little color information, in an 8×8 region. Because of the existence of the Z pixels, in an RGBZ image, the red, green and blue colors are more sparsely sampled than in a standard Bayer image. Due to these holes in the data image, commonly used demosaicing algorithms for the standard Bayer Color Filtering Arrays cannot be applied directly. Depth pixels could be infrared (“IR”) sensing pixels.

Holes in the image data diminish the quality of the eventual image. Some techniques have been proposed for repairing holes in the image data, but have drawbacks. Deinterlacing fills in missing lines in a video frame, and Inpaint repairs damaged or obstructive images. Both techniques typically fill in the missing information by interpolation from surrounding pixels. These techniques can generate lower resolution blurry edges, and can be computationally intensive for real time processing. Moreover, these techniques can't be applied to demosaiced color images directly.

### BRIEF SUMMARY

The present description gives instances of devices, software and methods, the use of which may help overcome problems and limitations of the prior art.

In some embodiments, an imaging device includes a pixel array with a hole within its pixels, and an image signal processor configured to process data generated by the pixels. In a process hereby called “Patch-Clone”, holes in image data are repaired for the eventually rendered image. More particularly, a patch of the pixels can be selected on the basis of how well the data of pixels surrounding the patch match data of pixels surrounding the hole. Then the data of the patch can be cloned, and become rendered instead of the missing data of the hole.

An advantage over the prior art is that, by choosing a patch whose boundary matches the boundary of the hole, local image structure is preserved.

These and other features and advantages of this description will become more readily apparent from the following Detailed Description, which proceeds with reference to the drawings, in which:

### BRIEF DESCRIPTION OF THE DRAWINGS

FIG. 1 is a block diagram of an imaging device made according to embodiments of the invention.

FIG. 2A is a diagram showing a sample prior art pixel array with a hole, in which case specifically the pixel array is for color pixels and the hole is pixels used for depth determination.

FIG. 2B is a diagram showing sample imaged color data for the pixel array of FIG. 2A, illustrating that pixels corresponding to the hole do not contribute much useful color information.

FIG. 3 is a conceptual diagram for describing elements relating to an operation of an image signal processor of FIG. 1, according to embodiments.

FIG. 4 is a flowchart for illustrating methods according to embodiments of the invention.

FIG. 5A is a diagram of sample data of a sample pixel array, along with two possible identified candidate patches plus their surrounding pixels that are considered according to embodiments.

FIG. 5B is a diagram of the data of only the pixels in the array of FIG. 5A that will be used to resolve which candidate patch will be selected, according to some embodiments.

FIG. 5C is a diagram showing sample coordinate values that are used for computing statistics according to embodiments.

FIG. 5D is a diagram showing a cloning operation after the selection of FIG. 5B, according to embodiments.

FIG. 5E is a diagram showing the resulting rendered pixel data from the cloning of FIG. 5D, according to embodiments.

FIG. 6 depicts equations that may be used for a matching operation according to embodiments.

FIGS. 7A-7G depict equations that may be used for a cloning operation according to embodiments.

FIG. 8 depicts a controller-based system for an imaging device, which uses an imaging array made according to embodiments.

### DETAILED DESCRIPTION

As has been mentioned, the present description is about repairing holes in image data. Embodiments are now described in more detail.

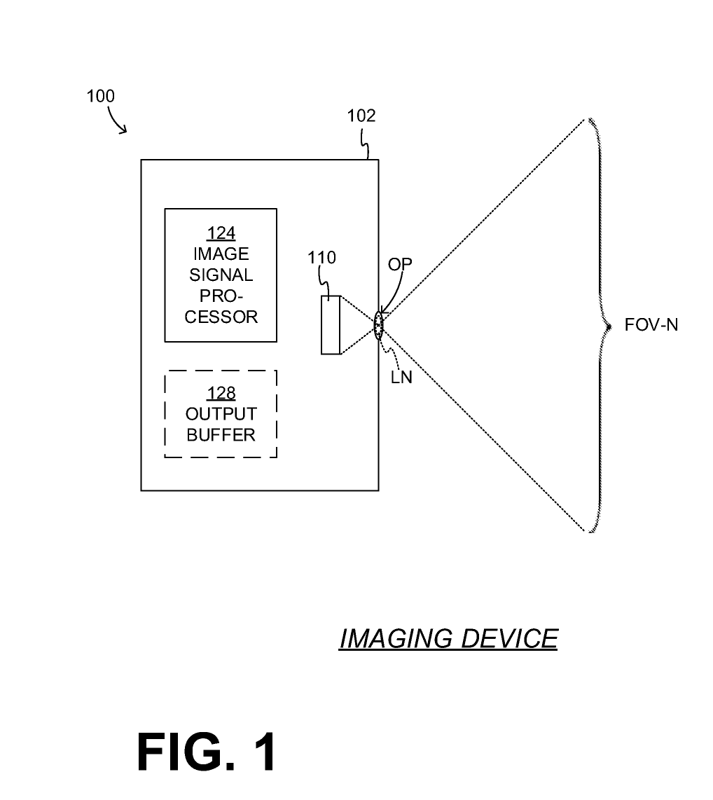

FIG. 1 is a block diagram of an imaging device 100 made according to embodiments. Imaging device 100 can be for any number of applications, such as visible imaging, dynamic vision sensing, proximity sensing, and so on. Imaging device 100 has a casing 102, and includes an opening OP in casing 102. A lens LN may be provided optionally at opening OP, although that is not necessary. Lens LN would, of course, be of a material that allow through the electromagnetic radiation that is to be imaged. This radiation could be visible light for a light image, IR light, and so on.

Imaging device 100 also has a pixel array 110 made according to embodiments. Pixel array 110 is configured to receive electromagnetic radiation, such as visible light, through opening OP from an object, person, or scene, which is to be imaged by imaging device 100. As can be seen, pixel array 110 and opening OP define a nominal Field of View FOV-N. Of course, Field of View FOV-N is in three dimensions, while FIG. 1 shows it in two dimensions. Further, if lens LN is indeed provided, the resulting actual field of view may be different than the nominal Field of View FOV-N. Imaging device 100 is aligned so that the object, person, or scene that is to be imaged is within the actual field of view.

In many embodiments, pixel array 110 has a two-dimensional array of pixels. The array can be organized in rows and columns. The pixels are typically sensitive to the electromagnetic radiation of interest. In visual imaging applications, the pixels may be photosensitive devices, such as photodiodes or pinned photodiodes. When pixels receive light, they generate a corresponding amount of electrical charge that ultimately encodes image data from the captured image. Color pixels thus generate color image information. Accordingly, the pixels of pixel array 110 can capture individual elements of the image. Due to the entire array 110, imaging device 100 can capture the image within the actual field of view. In some embodiments, the pixels can be bolometer type sensors, for example microbolometers.

Device 100 additionally includes an image signal processor 124. Processor 124 receives the image data generated by pixel array 110, perhaps after some preliminary processing, amplification, and brief storage in an intermediate buffer memory. Processor 124 then renders a processed image by sometimes performing a processing operation on the image data. The processed image can be displayed, stored for the long term, and so on.

Device 100 optionally also includes an output buffer 128. If provided, output buffer 128 stores the processed image data rendered by image signal processor 124. The processed image data can be displayed, or stored for the long term, by being read from output buffer 128.

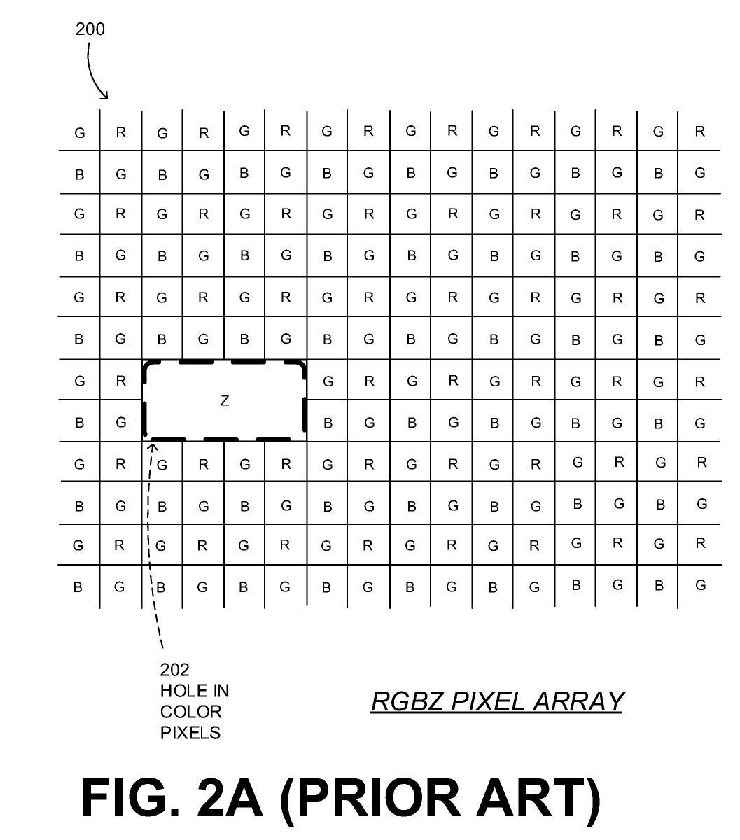

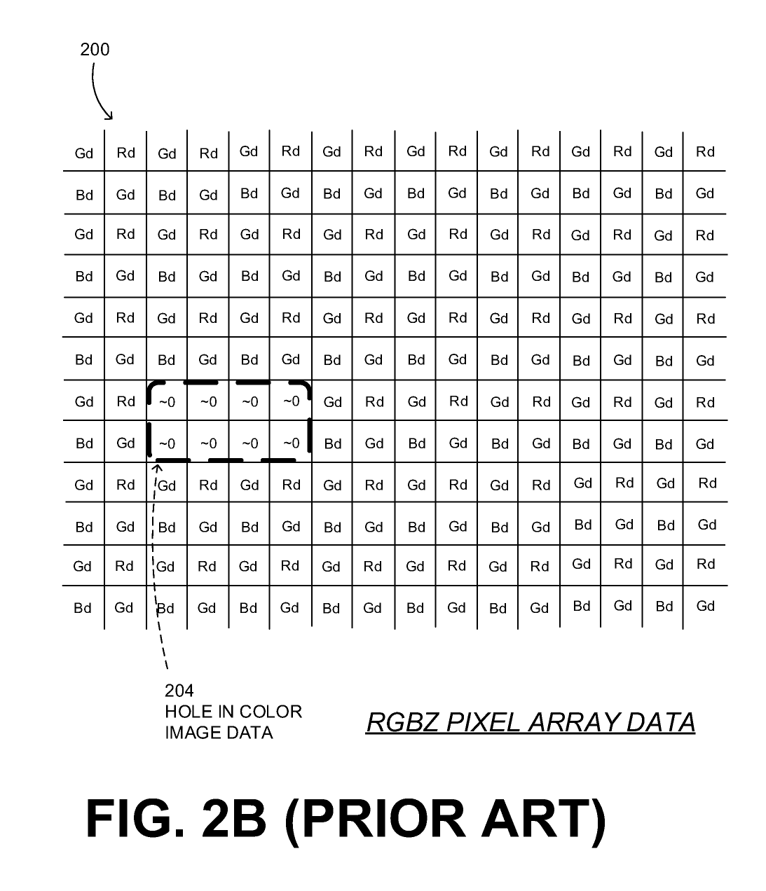

FIG. 2A is a diagram showing a sample prior art pixel array 200 having a hole 202. In the particular example of FIG. 2A, the array is an RGBZ array. Color pixels are designated as “R” for Red, “G” for Green, and “B” for blue, while one or two pixels for depth determination are designated as “Z”. Other arrays could have other types of holes, and for different reasons, such as a bad pixel and/or deterioration of performance with time.

FIG. 2B is a diagram showing sample imaged color data 203 received from the pixels of array 200 of FIG. 2A. Data 203 is presented in a two-dimensional array that is arranged the same as pixel array 200. The coordinates are typically in two dimensions, such as by according to row and column. As such, the image is defined when the image data is rendered according to these coordinates.

It will be appreciated that the image data for R, G, and B pixels are correspondingly shown as Rd, Gd and Bd. The image data for the one or two Z pixels is a small number, shown in FIG. 2B as approximately zero (“^{˜}0”), and therefore do not contribute much useful information. If seem in color, they would appear substantially black. As such, from hole 202 in the color pixels, there effectively results a hole 204 in the color image data, from which useful color image data is missing. While a hole is thus defined as a group of substantially inoperative pixels, that need not be the case for the present invention. For example, a hole can be defined as a block of pixels, such as a rectangle, which contains a substantial number of randomly distributed missing pixels, in which case the entire block will be patched even though it contains working pixels.

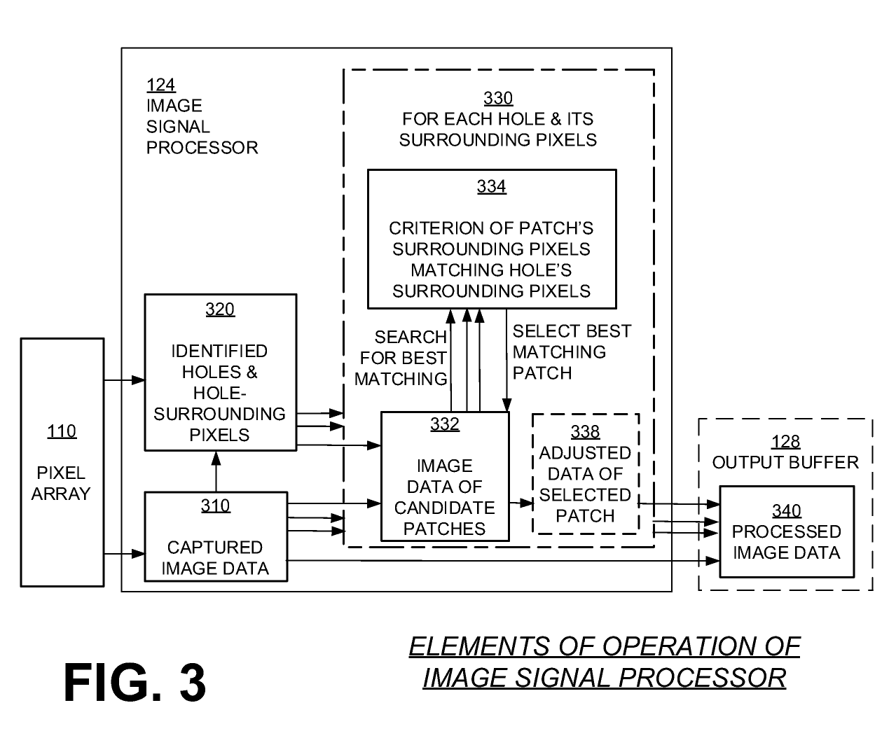

FIG. 3 is a conceptual diagram for describing elements relating to an operation of an image signal processor of FIG. 1, according to embodiments. These elements will also be understood in view of the description of subsequent drawings.

In FIG. 3, image signal processor 124 receives captured image data 310 from pixel array 110. A picture of captured image data 310 was given in FIG. 2B.

In addition, processor 124 inputs element 320, which is information about identified holes in image data 310. Element 320 can be input in any number of ways. In some instances it is known from the identity of pixel array 110, for example as in FIGS. 2A and 2B. In other instances, element 320 is determined by analyzing captured image data 310, and searching for values such as those in hole 204 of FIG. 2B, or other values evidencing a problem. Other criteria may also be used, for example repeating such analysis and search to confirm that indeed the underlying pixel or pixels do not work well any more for multiple images.

According to an element 330, processor 124 processes the image data for each hole, and generates replacement image data for the missing image data of the hole. The replacement image data can be substituted for the hole in captured image data 310, so as to generate processed image data 340. In other embodiments, there is more processing so as to generate processed image data 340, and so on. Processed image data 340 may be presented in terms of coordinates that match coordinates of the pixels of pixel array 110, as was done with the correspondence of FIG. 2B and FIG. 2A. Image data 340 may be stored in output buffer 128, if provided.

Element 330 in particular may include image data 332 for identified candidate patches, intended to provide the replacement data for the hole in question. Element 330 may also include a criterion 334, for selecting the best matching of the identified candidate patches. Element 330 may also include an optional element 338, which is the adjusted data of the selected patch that is ultimately used as the replacement data for the hole.

The above elements of image signal processor 124 are described in terms of functions, processes and methods that can be performed. Imaging device 100, and image signal processor 124, may perform such functions, processes and methods by one or more devices that include logic circuitry. The logic circuitry may include a processor that may be programmable for a general purpose, or dedicated, such as microcontroller, a microprocessor, a Digital Signal Processor (DSP), etc. The logic circuitry may also include storage media, such as a memory. Such media include but are not limited to read only memory (ROM); random access memory (RAM); magnetic disk storage media; optical storage media; smart cards, flash memory devices, etc. Such a storage medium can be a non-transitory computer-readable medium. These storage media, individually or in combination with others, can have stored thereon programs that the processor may be able to read. The programs can include instructions in the form of code, which the processor may be able to execute upon reading, which result in functions, processes and methods being performed. Executing is performed by physical manipulations of physical quantities.

Moreover, methods and algorithms are described below. These methods and algorithms are not necessarily inherently associated with any particular logic device or other apparatus. Rather, they are advantageously implemented by programs for use by a computing machine, such as a general-purpose computer, a special purpose computer, a microprocessor, etc.

Often, for the sake of convenience only, it is preferred to implement and describe a program as various interconnected distinct software modules or features, individually and collectively also known as software. This is not necessary, however, and there may be cases where modules are equivalently aggregated into a single program, even with unclear boundaries. In some instances, software is combined with hardware, in a mix called firmware.

This detailed description includes flowcharts, display images, algorithms, and symbolic representations of program operations within at least one computer readable medium. An economy is achieved in that a single set of flowcharts is used to describe both programs, and also methods. So, while flowcharts described methods in terms of boxes, they also concurrently describe programs.

Methods are now described.

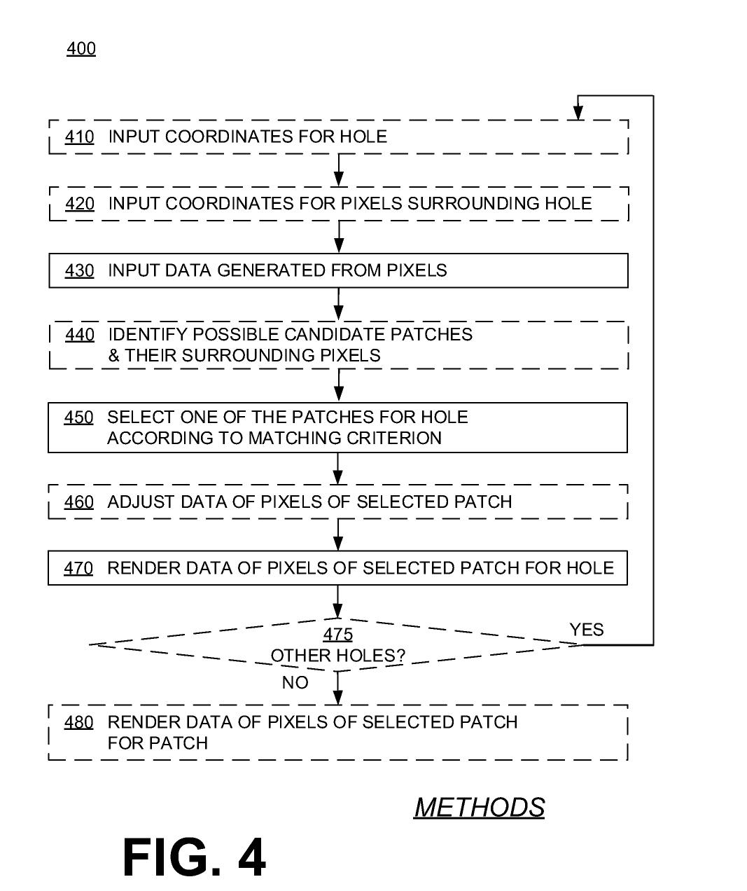

FIG. 4 shows a flowchart 400 for describing methods according to embodiments. The methods of flowchart 400 may also be practiced by embodiments described in this document, such as by image signal processor 124, a controller, and so on.

According to an operation 410, coordinates are input for a hole in the pixels or, equivalently, in the pixel data. The coordinates of the hole would be with reference to the coordinates of the pixels, or the image data, and can be input in different ways, such as described above. An example is now described.

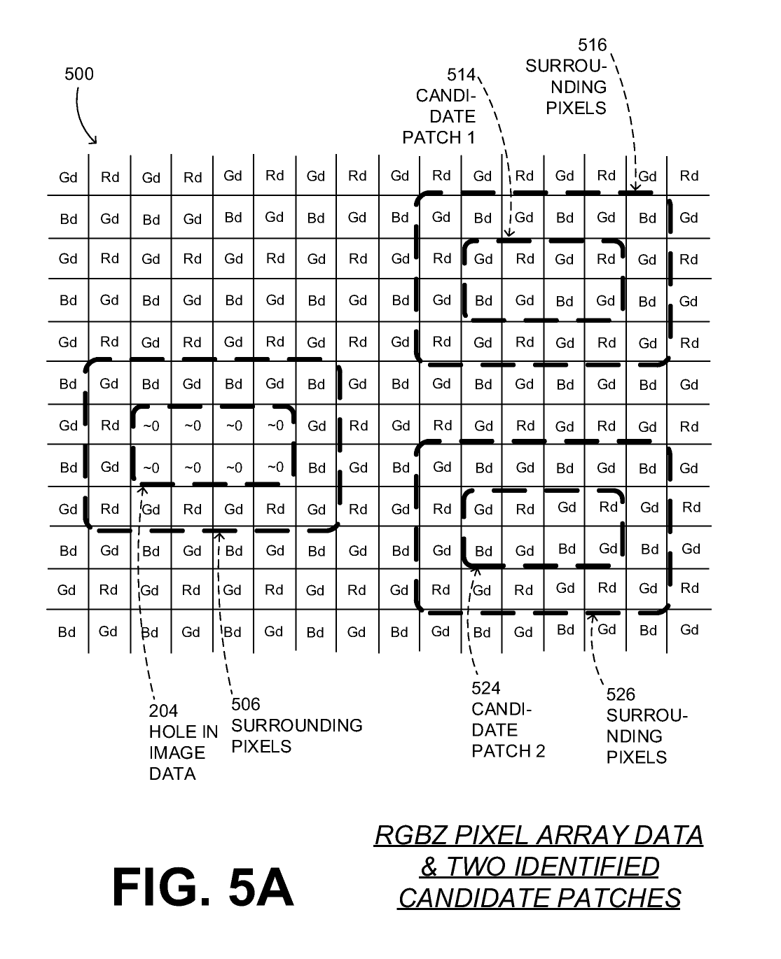

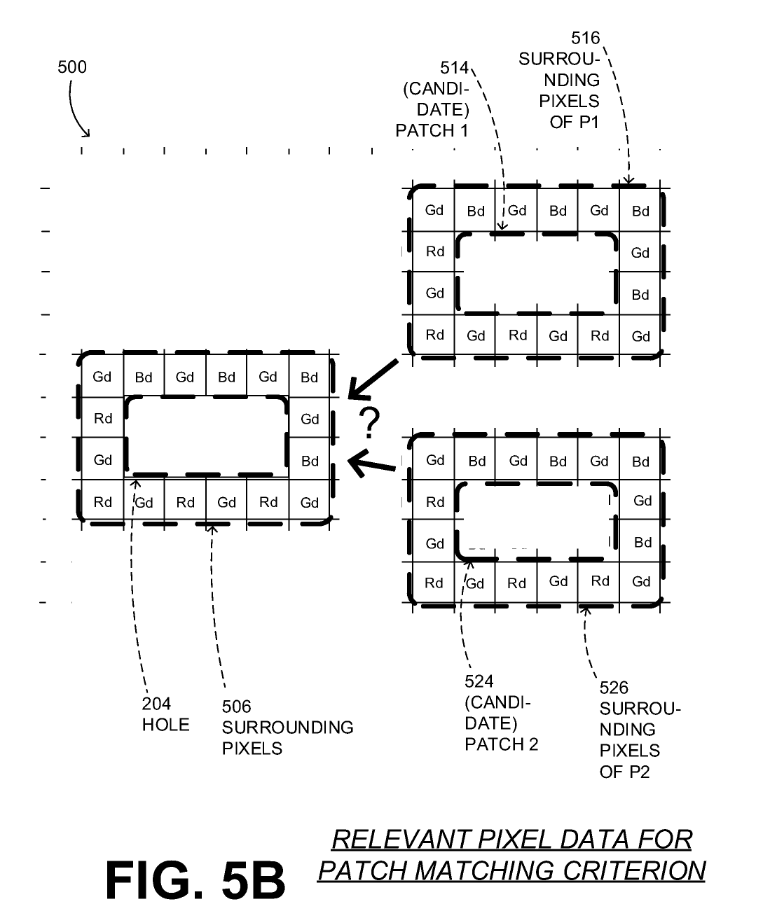

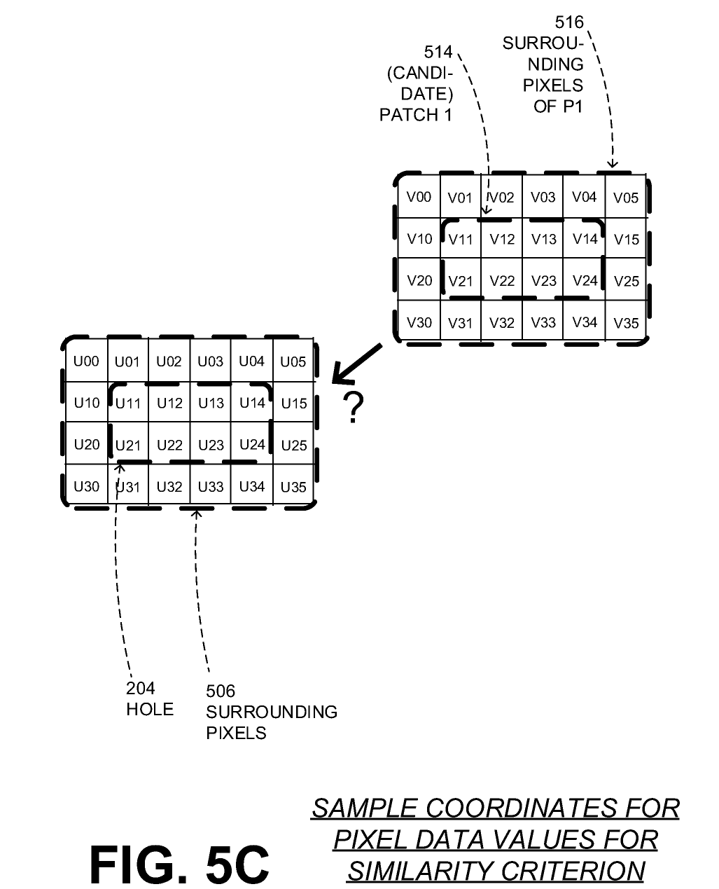

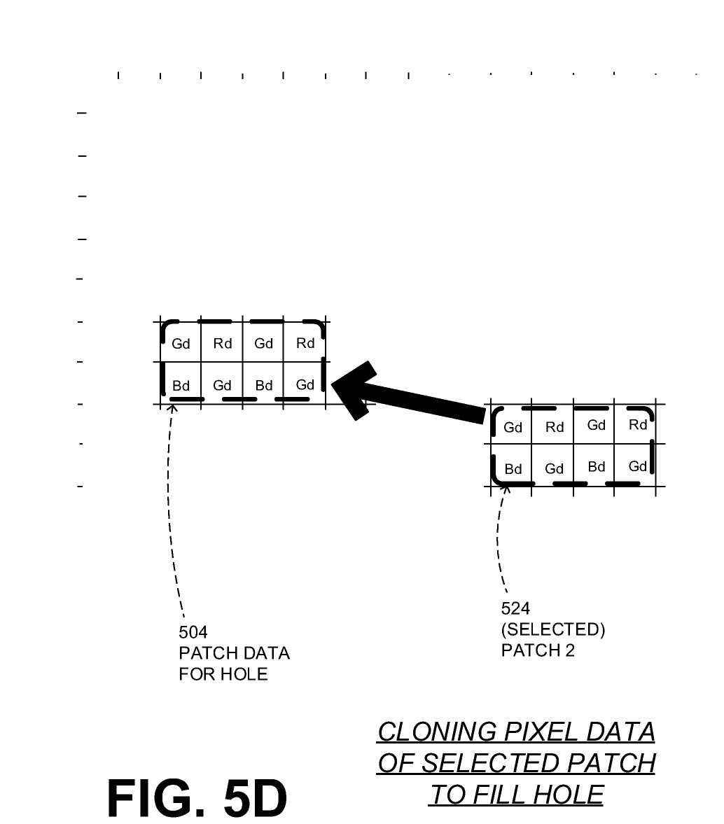

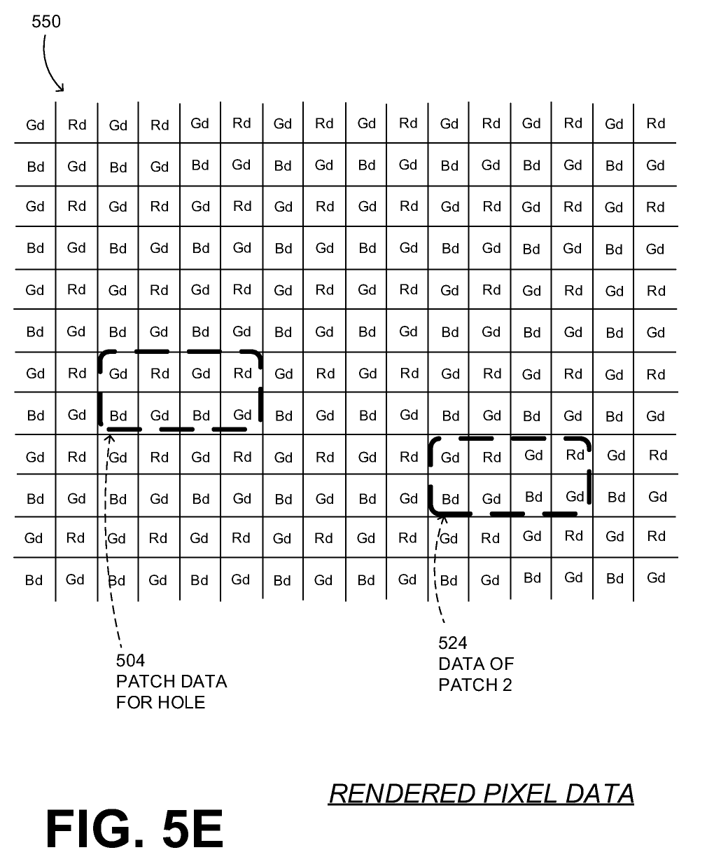

FIG. 5A is a diagram of sample data 500 of a sample pixel array, which in this case is also the array of FIG. 2A. Data 500 can be the data of FIG. 2B, with further indications of additional features according to embodiments. The coordinates that would be input for operation 410 are the coordinates of pixels 202 of FIG. 2A.

According to an optional next operation 420, coordinates are input for pixels surrounding the hole. This data, along with the data of operation 410, can be seen as element 320 in FIG. 3. These coordinates can be input in different ways, for example similarly with the coordinates for the hole itself. As such, they can be known in advance, or discovered for a pixel whose performance has deteriorated later, and so on. In FIG. 5A, the surrounding pixels are those that have the data designated as 506, but excluding those that have the data designated as 204.

In some embodiments, although not necessary for practicing the invention, the pixels surrounding the hole are chosen to be ones adjacent to the hole. Adjacency can be by sharing a side, or just a point along a diagonal line. And, in some embodiments, the pixels surrounding the hole are chosen to be ones that surround the hole completely.

In the some embodiments, although not necessary for practicing the invention, the pixels are imaging pixels, and the hole includes one or more depth pixels. Additionally, the pixels surrounding the hole can be chosen in different ways. For example, the pixels surrounding the hole can be pixels that are 8-connected to any pixel belonging in the hole. The imaging pixels may be color pixels, grays-cale pixels, and so on, for obtaining image data.

Returning to FIG. 4, according to an optional operation 430, image data is inputted or received, which has been generated from the pixels. These data can be seen as data 500 of FIG. 5A, and also as element 310 in FIG. 3, and may be used for processing and ultimately rendering.

According to another optional operation 440, possible candidate patches are identified, along with their surrounding pixels. In FIG. 5A, data for two candidate patches are shown, namely patch 1 and patch 2. The patches are the pixels carrying the data designated as 514 for patch 1 and 524 for patch 2. Moreover, the surrounding pixels of patch 1 are the pixels having the values designated as 516, but excluding those of patch 514, and the surrounding pixels of patch 2 are the pixels having the values designated as 526, but excluding those of patch 524.

While only two patches are identified in FIG. 5A, that is only for example and not an intended limitation. In fact, it is beneficial to identify as many candidate patches as practicable so as to achieve better matching, but without unduly delaying the speed of processing.

Different kinds of patches may be sought. In some embodiments, as above, the patch is the size of the hole, and only one patch is used, although that is not necessary for practicing the invention. In fact, two or more patches could be used for filling different portions of a single hole. Further, in considering candidate patches, the pixels surrounding a candidate patch can also be considered. For example, the pixels surrounding the candidate patch can be advantageously chosen to match, in some way, pixels surrounding the hole.

A candidate patch can be a local patch that has a size that is the same as a size of the hole, and preferably also the same shape. A candidate patch plus its surrounding pixels can be the same size as the hole plus its surrounding pixels, the latter of which can be thought of as a template. Candidate patches may be found that retain the generality of a Bayer pattern in the resulting image, when cloned to fill in the hole. More particularly, the pixels can be color pixels in a pattern of R, G, B, for example as seen in FIG. 2A. In such embodiments, the candidate patches have a color order that is the same as a color order that would be defined by the pattern for the hole.

Returning to FIG. 4, according to a next operation 450, one of the candidate patches is selected according to a matching criterion. There can be many matching criteria according to embodiments. In many embodiments, selecting has two components. First, a similarity statistic may be defined and considered for each candidate patch as to the data of pixels surrounding the candidate patch with the data of pixels surrounding the hole. Second, a choosing rule may be implemented, as to which candidate to select, based on its similarity statistic. As such, in many embodiments, selecting is performed according to which one of the candidate patches has pixels surrounding it with data that best meet the choosing rule about the similarity statistic with the data of pixels surrounding the hole. In many embodiments, the choosing rule is that the patch having the highest similarity statistic is selected, although other choices are possible. An example is now described.

FIG. 5B is a diagram of the data of only the pixels in the array of FIG. 5A that will be used to resolve which one of the two sample candidate patches will be selected, for filling in the hole. The competing candidacies are shown by an arrow in FIG. 5B. Selecting may be performed according to which patch's surrounding pixels' data, whose outlines are respectively 516, 526, better meet a similarity statistic with the data of pixels surrounding the hole, whose outline is 506.

There are many possibilities for a similarity statistic. The similarity statistic may be computed according to the values of data. Computations may be performed on the basis of the coordinates of the pixels. An example is now described.

FIG. 5C is a diagram showing sample coordinate values that are used for computing statistics according to embodiments. In the example of FIG. 5C, only the first patch is shown as being studied, when in fact multiple patches should be so analyzed. Data of pixels of the hole can have values designated as u(row, column), and data of pixels of each patch can have values designated as v(row, column). To conserve space in FIG. 5C, instead of u(0,0), U00 is written, and so on with the others. The coordinates can be either local with respect to the patch and the hole, or global with respect to the array. Sample calculations are presented later in this document.

In some embodiments, the similarity statistic is maximized, i.e. has a maximum value, when a difference statistic is made a minimum. The difference statistic may be defined in a number of ways. One such way is the sum of the squared pixel data differences between the data of pixels surrounding the candidate patch, and the data of pixels surrounding the hole that correspond to the data of pixels surrounding the candidate patch according to their location relative to the patch. For example, in FIG. 5C the differences can be pairwise between V00 and U00, V01 and U01, V02 and U02, and so on. These are the differences that would result by superimposing the pixels surrounding the patch on the pixels surrounding the hole, which can be thought of as a template.

According to an optional next operation 460, the data of the pixels of the selected patch is adjusted. The adjusting may be performed in many ways. In many embodiments, the adjusting is performed in view of the data of the pixels surrounding the selected patch, or the hole, and examples will be seen later in this document.

According to a next operation 470, the data of the pixels of the selected patch is rendered as the data of the hole. In other words, the patch is used to fill the hole. An example is now described.

FIG. 5D is a diagram showing cloning among data 500. In this example, the patch that was selected is patch 2, and its data is copied, or cloned, so that it also becomes data 504 for the hole. FIG. 5D shows only the cloning, but not any adjustment as may be performed by operation 460.

According to an optional next operation 475 of flowchart 400, it is inquired whether there are any other holes in the pixels, and therefore in the image data, for repairing. If so, execution returns to operation 410 for the next hole, and the process is repeated. For example, in an RGBZ array, there are many Z pixels arranged in regular intervals, and the entire process above can be repeated for each of them.

If not, then according to an optional next operation 480, the data of the pixels of the selected patch is rendered as the data of the patch. This preferably takes place as the remainder of the data for the entire image takes place, in addition to the data generated for the holes. This way a full image can be reconstructed. An example is now described.

FIG. 5E is a diagram showing the resulting rendered pixel data 550, according to embodiments. It will be observed that the full image has been reconstructed. In contrast to FIG. 5A, the hole has been patched with data 504, which has initially been derived from selected patch 2. Plus, data 524 of the pixels of selected patch 2 shown in FIG. 5A has been rendered as data 524 of patch 2 in FIG. 5E.

The invention need not be practiced only on color pixels. When practiced on color pixels, the selecting of operation 450 and rendering of operation 470 can be performed on color data that has not been demosaiced.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Moreover, in certain embodiments, new operations may be added, or individual operations may be modified or deleted. The added operations can be, for example, from what is mentioned while primarily describing a different system, device or method.

A person skilled in the art will be able to have the operations above performed by an image device according to embodiments. Additional description is now provided for this effect.

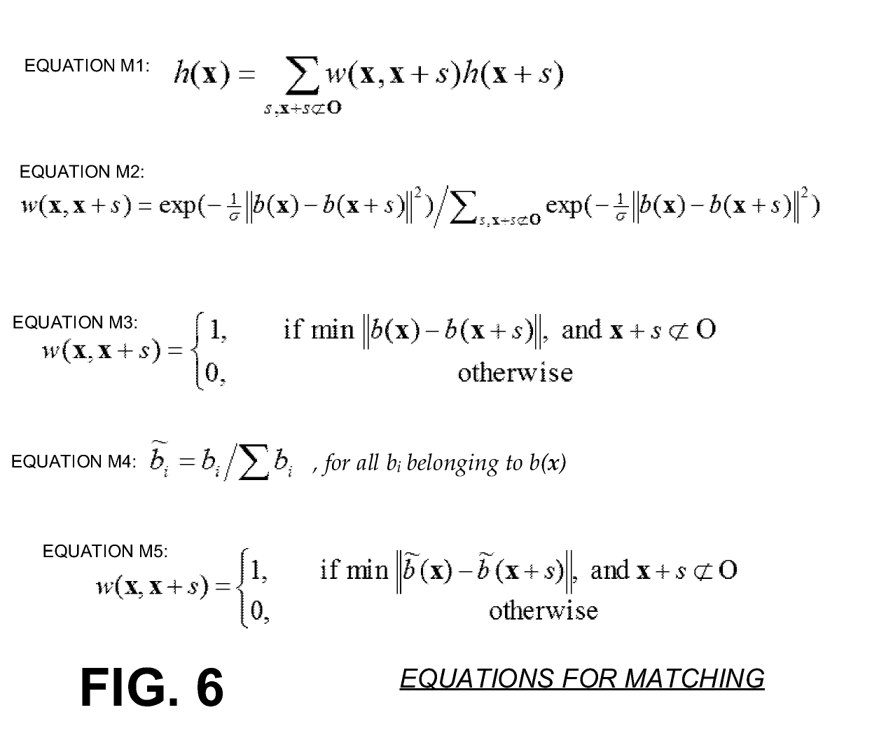

FIG. 6 depicts equations that may be used for a matching operation according to embodiments, such as operation 450. For matching, a model can be first formulated in a more general form. Given O the set of all locations of pixels that belong to the holes in an image, let x denote a set of pixel locations of a single hole, i.e. x⊂O. (Bolded variables mean vectors.) Let h(x) be the set of pixels at location x, and b(x) is the set of pixels on the boundary of the hole, provided b(x)∩h(O)=Ø. Here, “boundary” means the surrounding pixels.

Then one can start from the general framework of the classic non-local approach, and use Equation M1. In Equation M1, “+” is the shift operator for offset s, which defines the size of the neighborhood around x. The condition (x+s)⊂O explicitly excludes the case that x+s is in a hole, e.g. when s=0.

The weight function w measures the similarity between two patches. In the classic non-local framework, where Gaussian weights are commonly used, w can be given by Equation M2, where ∥.∥ is the L-2 normal of two vectors, and σ defines the shape of Gaussian.

In one embodiment, we set σ→0. Then w becomes equivalent to an impulse function, and Equation M2 becomes Equation M3. The definition of the weight function w in Equation M3 allows us to find the best matching candidate, at location y, and use it to fill in the hole.

Alternatively, the weight w can be luminance-invariant when the boundary pixels are normalized according to Equation M4. Then w can be expressed as shown in Equation M5. The luminance-invariant weight function allows one to compute the difference between two patches when they differ because of texture rather than luminance.

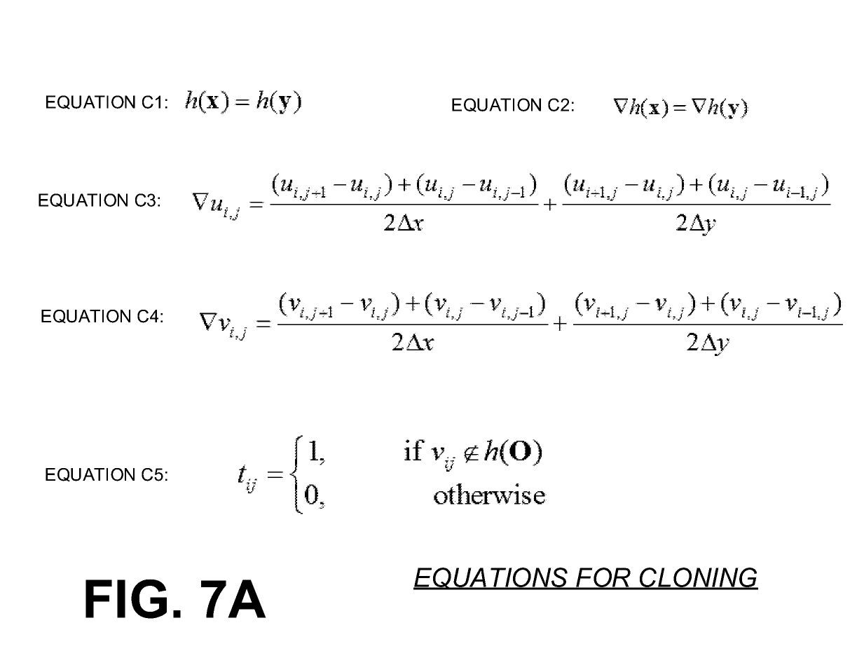

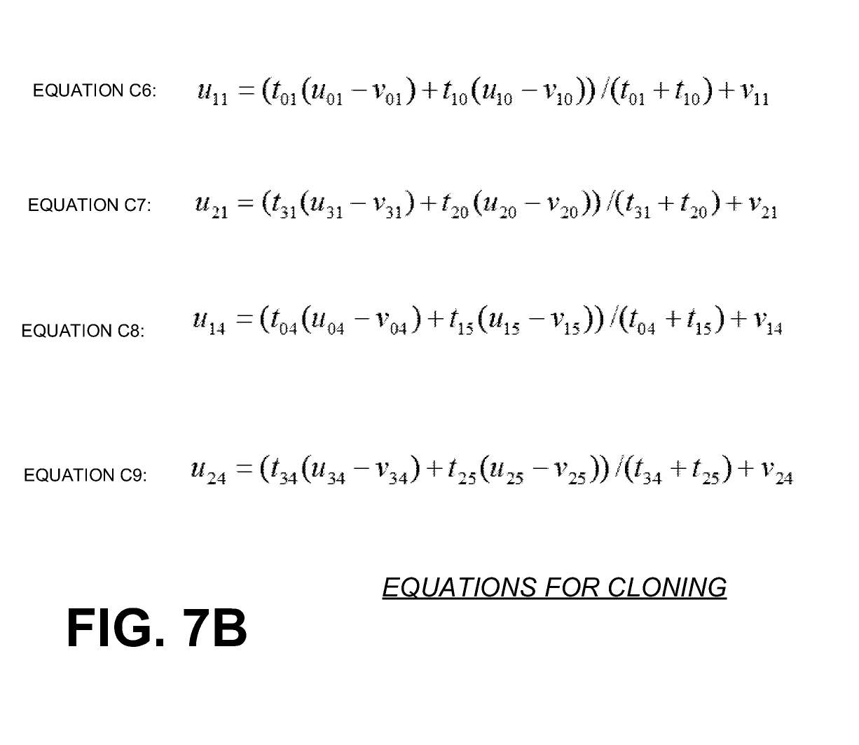

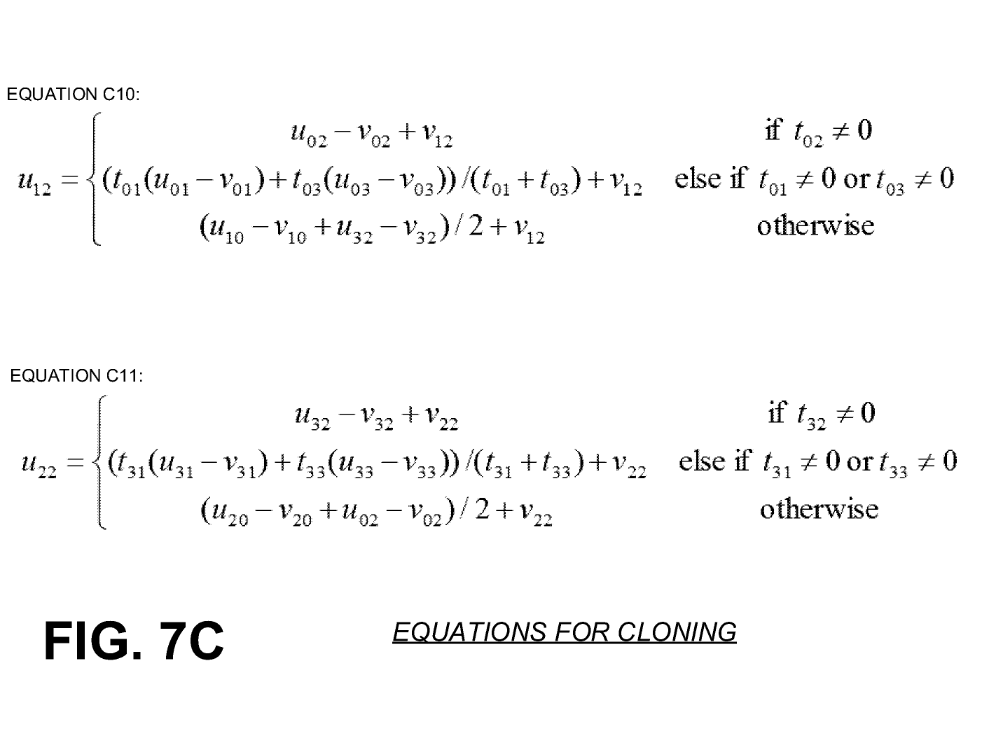

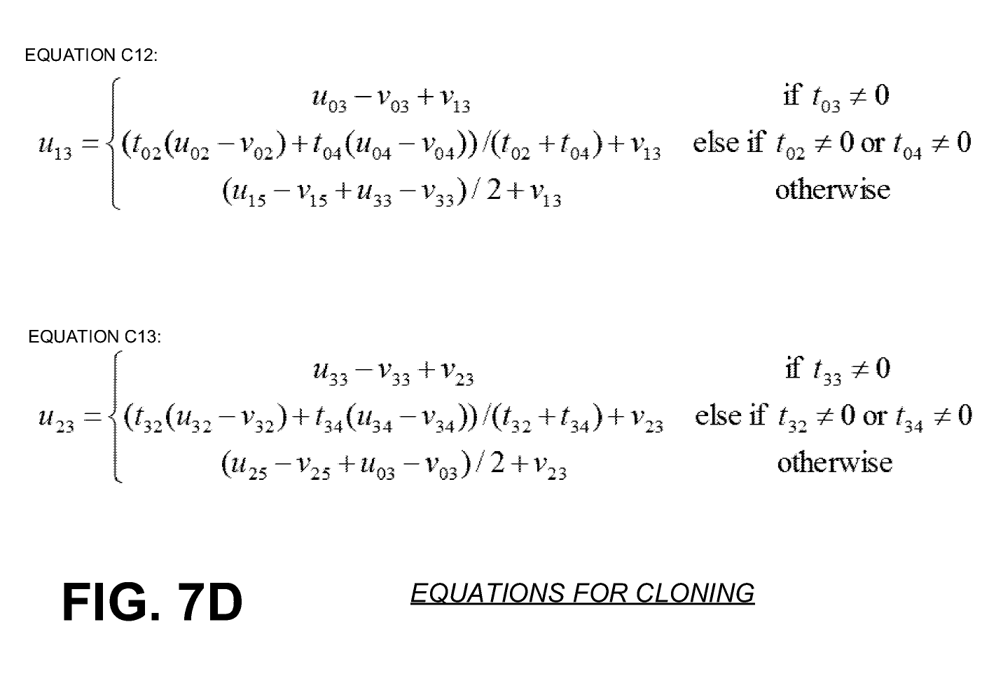

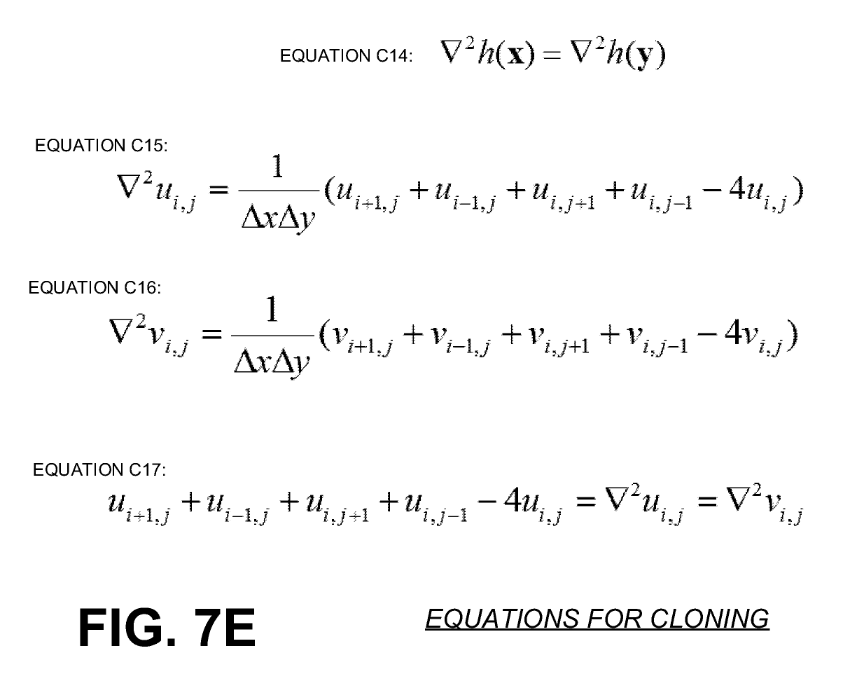

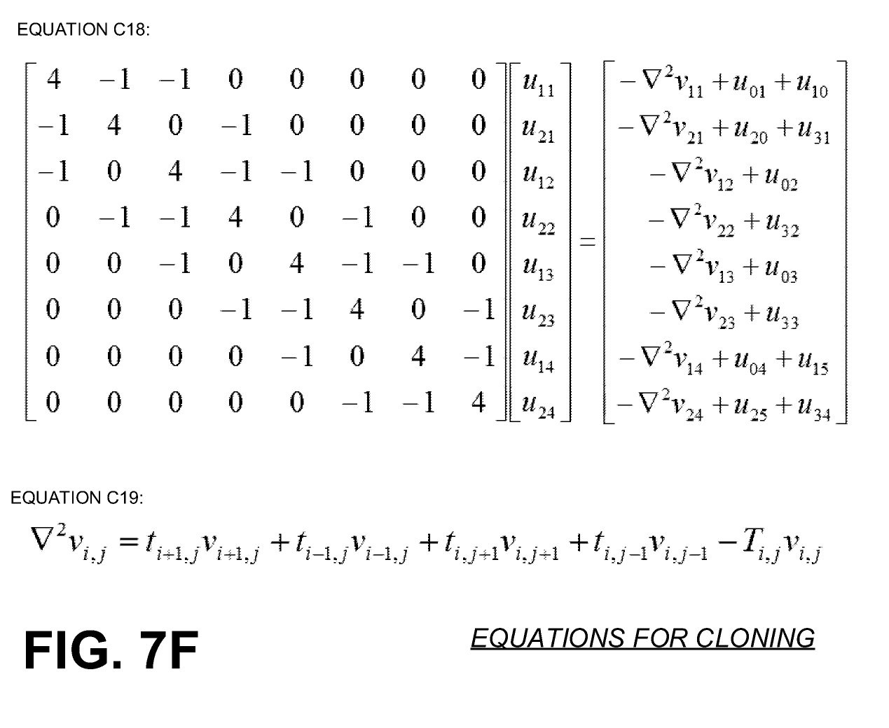

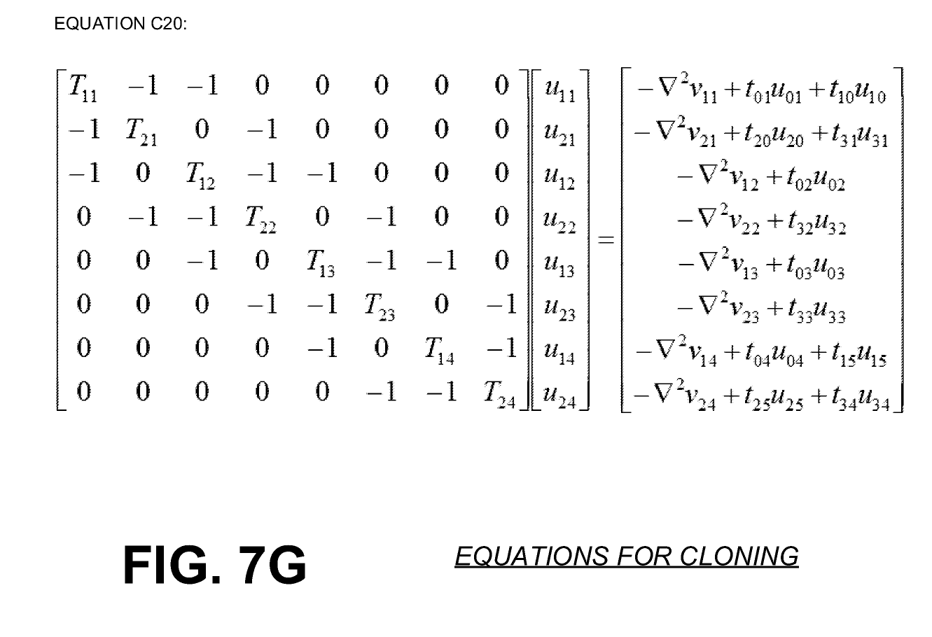

For cloning operations, once the best matching candidate is identified, its content can be used to fill in the hole of the template. For the description that follows, the hole and its surrounding pixels can be considered as a template at a location x, and the best matching patch and its surrounding pixels can be considered at a location y. Values, and coordinate naming, can be learned with reference to FIG. 5C where v values were given for patch 1, but which was not the best matching patch. It should be remembered that, for the discussion that follows, the patch is instead the best matching patch. Moreover, FIGS. 7A-7G depict equations that may be used for a cloning operation according to embodiments.

There are a number of ways for such filling, and three are described in detail here: 1) by pixel values (0^{th}-order), 2) by the pixel gradient (1^{st}-order), and 3) by Laplacian (2^{nd}-order).

1) Copy by Value (Zeroth Order Gradient)

In this case, the values of the patch are directly copied to hole of the template. This is also operation 470 of FIG. 4, when operation 460 does not take place. Mathematically, this can be represented by Equation C1. That is, u_{i,j}=v_{i,j}, for i=1, 2 and j=1, 2, 3, 4, where i and j are the local coordinates of the patch of FIG. 5C.

A challenge with the direct copying is that there is no guarantee of continuity between the data of the pixels surrounding the hole, and the new data that would fill in the hole. An undesirable byproduct can be a sharp intensity change, which can cause artifacts such as white or dark spots.

The other two ways of filling in include the adjustment of operation 460. Again, the adjusting is in view of the data of the pixels surrounding the selected patch, or the hole. The adjusting may attenuate any discontinuity between this data and the filled in data.

2) Copy by Gradient (First Order Gradient)

In this case, the gradient of the surrounding pixel values of the selected patch becomes cloned to the hole. Mathematically, this can be represented by Equation C2.

The gradient, denoted by V, can be defined as the change of pixel values in vertical and horizontal directions. In general, gradients can be defined by Equations C3 and C4, in which Δx and Δy are both 1.

A challenge with the above is that the pixels adjacent to a non-surrounding pixel are not always unknown, in the vertical and/or horizontal direction. For example, in FIG. 5C, (a) at pixel u₁₁, pixels u₁₂ and u₂₁ are not unknown; and (b) at pixel v₁₁, pixel v₀₁ is unknown if v₀₁εh(O). As such, the gradient can be redefined and the hole pixel can be computed in a case-by-case manner, to ensure all involved pixels are available. To this end, a function t can be defined that examines whether a pixel belongs to a hole, as in Equation C5. Then, the calculation of u₁₁, u₂₁, u₁₄, and u₂₄ can be defined as given in Equations C6-C9. And the calculations of u₁₂, u₂₂, u₁₃ and u₂₃ can be defined as given in Equations C10-C13.

One could first use non-hole surrounding pixels that are within a 4-connected neighborhood, to compute the gradient by Equation C7. If no such neighbor exists, one could use 8-connected neighbors. Otherwise, one could use pixels that are in horizontal and vertical directions in a 5×5 neighborhood.

The 1^{st}-order cloning imposes more continuity between the surrounding pixel data and the new hole data, but not necessarily continuity among the data of pixels of the hole. This is rectified in the next method.

3) Copy by Laplacian (Second Order Gradient)

In this case, a Laplacian of the pixel data of the patch becomes cloned to the hole. Mathematically, this can be represented by Equation C14. In this case, ∇² is the discrete 2D Laplacian operator defined by Equations C15 and C16. Combining Equations C14-C16, one gets Equation C17. Therefore, one may estimate all the values of u in the hole at once, by solving the linear system of equations shown as Equation C18 in FIG. 7F.

Similarly with the 1^{st} order case, when not all pixels in the selected patch are known, one might not be able to compute the Laplacian by Equation C16. Thus one could approximate the Laplacian function by using only available pixels, such as in Equation C19, where Tᵢⱼ=t_{i+1,j}+t_{i-1,j}+t_{i,j+1}+t_{i,j-1}, Accordingly, the linear system of Equation C18 can become modified to become Equation C20. Thus, the hole pixel data can be calculated by solving Equation C20.

It will be appreciated that the 2^{nd}-order cloning, when based on discrete Poisson equations, enforces continuity between pairs of data of adjacent pixels, both within the hole and with respect to the hole and its surrounding pixels, and therefore reduced potential artifacts.

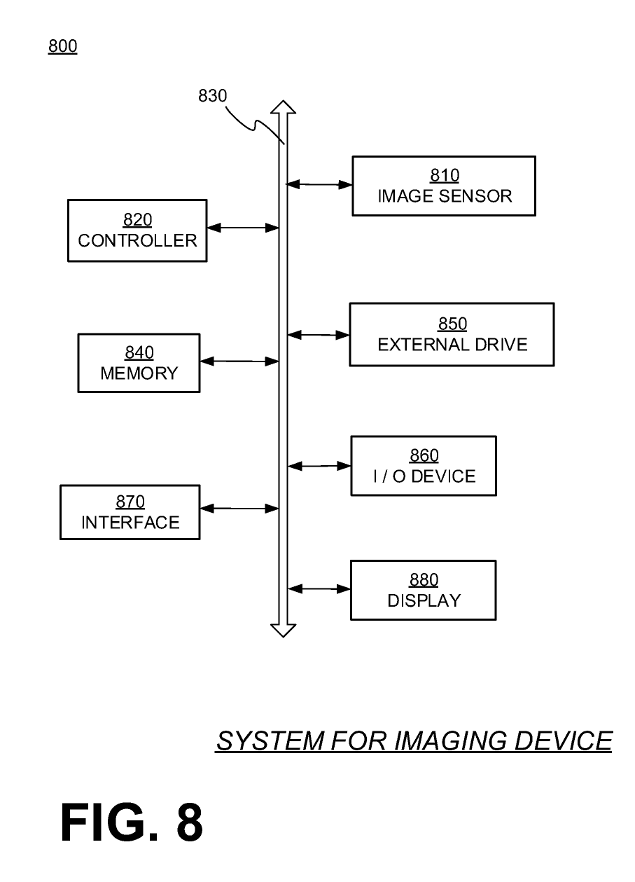

FIG. 8 depicts a controller-based system 800 for an imaging device made according to embodiments. System 800 could be for the device of FIG. 1.

System 800 includes an image sensor 810, which is made according to embodiments, such as by a pixel array. In some embodiments, image sensor 810 is pixel array 110. As such, system 800 could be, without limitation, a computer system, an imaging device, a camera system, a scanner, a machine vision system, a vehicle navigation system, a smart telephone, a video telephone, a personal digital assistant (PDA), a mobile computer, a surveillance system, an auto focus system, a star tracker system, a motion detection system, an image stabilization system, a data compression system for high-definition television, and so on.

System 800 further includes a controller 820, which is made according to embodiments. Controller 820 could include an image signal processor, such as processor 124 of FIG. 1. Controller 820 could be a Central Processing Unit (CPU), a digital signal processor, a microprocessor, a microcontroller, an application-specific integrated circuit (ASIC), a programmable logic device (PLD), and so on. In some embodiments, controller 820 communicates, over bus 830, with image sensor 810. In some embodiments, controller 820 may be combined with image sensor 810 in a single integrated circuit. Controller 820 controls and operates image sensor 810, by transmitting control signals from output ports, and so on, as will be understood by those skilled in the art.

Controller 820 may further communicate with other devices in system 800. One such other device could be a memory 840, which could be a Random Access Memory (RAM) or a Read Only Memory (ROM), or a combination. Memory 840 may include buffer 128, if provided. Memory 840 may be configured to store instructions to be read and executed by controller 820. Memory 840 may be configured to store images captured by image sensor 810, both for short term and long term.

Another such device could be an external drive 850, which can be a compact disk (CD) drive, a thumb drive, and so on. One more such device could be an input/output (I/O) device 860 for a user, such as a keypad, a keyboard, and a display. Memory 840 may be configured to store user data that is accessible to a user via the I/O device 860.

An additional such device could be an interface 870. System 800 may use interface 870 to transmit data to or receive data from a communication network. The transmission can be via wires, for example via cables, or USB interface. Alternately, the communication network can be wireless, and interface 870 can be wireless and include, for example, an antenna, a wireless transceiver and so on. The communication interface protocol can be that of a communication system such as CDMA, GSM, NADC, E-TDMA, WCDMA, CDMA2000, Wi-Fi, Muni Wi-Fi, Bluetooth, DECT, Wireless USB, Flash-OFDM, IEEE 802.20, GPRS, iBurst, WiBro, WiMAX, WiMAX-Advanced, UMTS-TDD, HSPA, EVDO, LTE-Advanced, MMDS, and so on.

One more such device can be a display 880. Display 880 can show to a user a tentative image that is received by image sensor 810, so to help them align the device, perhaps adjust imaging parameters, and so on.

This description includes one or more examples, but that does not limit how the invention may be practiced. Indeed, examples or embodiments of the invention may be practiced according to what is described, or yet differently, and also in conjunction with other present or future technologies.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment, extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

1. An imaging device comprising:
a pixel array having pixels configured to generate data in response to exposure to an image, the pixel array having at least one hole within the pixels; and
an image signal processor configured to:
input the generated data,
select one of a plurality of candidate patches of the pixels, the selecting according to which one of the candidate patches has pixels surrounding it with data that best meet a choosing rule about a similarity statistic with the data of pixels surrounding the hole, and
render the data of the pixels of the selected patch as the data of the hole.

2. The device of claim 1, further comprising:
an output buffer for storing the rendered data.

3. The device of claim 1, in which the image signal processor is further configured to:
input coordinates for the hole, and
input coordinates for the pixels surrounding the hole.

4. The device of claim 1, in which
the pixels surrounding the hole are adjacent to the hole.

5. The device of claim 1, in which
the pixels surrounding the hole surround the hole completely.

6. The device of claim 1, in which
the pixels are imaging pixels,
the hole includes one or more depth pixels, and
the pixels surrounding the hole are pixels that are 8-connected to any pixel belonging in the hole.

7. The device of claim 1, in which the image signal processor is further configured to:
identify the plurality of candidate patches.

8. The device of claim 1, in which
the pixels are color pixels in a pattern of R, G, B, and
the candidate patches have a color order that is the same as a color order that would be defined by the pattern for the hole.

9. The device of claim 1, in which
the patch has a size that is the same as a size of the hole.

10. The device of claim 1, in which
the choosing rule is that the patch having the highest similarity statistic is chosen.

11. The device of claim 1, in which
the similarity statistic is maximized when a difference statistic is a minimum, the difference statistic being the sum of the squared pixel data differences between the data of pixels surrounding the candidate patch, and the data of pixels surrounding the hole that correspond to the data of pixels surrounding the candidate patch according to their location relative to the patch.

12. The device of claim 1, in which the image signal processor is further configured to:
adjust the data of the pixels of the selected patch prior to rendering them.

13. The device of claim 12, in which
the adjusting is in view of the data of the pixels surrounding one of the selected patch and the hole.

14. The device of claim 1, in which
the pixels have another hole within them, and
further comprising:
selecting another one of the candidate patches of the pixels according to the matching criterion; and
rendering the data of the pixels of the other selected patch as the data of the other hole.

15. The device of claim 1, in which the image signal processor is further configured to:
render the data of the pixels of the selected patch as the data of the patch.

16. The device of claim 1, in which
the selecting and rendering is performed on color data that has not been demosaiced.

17. A method, comprising:
inputting data generated from a plurality of pixels that have a hole within them;
selecting one of a plurality of candidate patches of the pixels, the selecting according to which one of the candidate patches has pixels surrounding it with data that best meet a choosing rule about a similarity statistic with the data of pixels surrounding the hole; and
rendering the data of the pixels of the selected patch as the data of the hole.

18. The method of claim 17, further comprising:
inputting coordinates for the hole; and
inputting coordinates for the pixels surrounding the hole.

19. The method of claim 17, in which
the pixels surrounding the hole are adjacent to the hole.

20. The method of claim 17, in which
the pixels surrounding the hole surround the hole completely.

21. The method of claim 17, in which
the pixels are imaging pixels,
the hole includes one or more depth pixels, and
the pixels surrounding the hole are pixels that are 8-connected to any pixel belonging in the hole.

22. The method of claim 17, further comprising:
identifying the plurality of candidate patches.

23. The method of claim 17, in which
the pixels are color pixels in a pattern of R, G, B, and
the candidate patches have a color order that is the same as a color order that would defined by the pattern for the hole.

24. The method of claim 17, in which
the patch has a size that is the same as a size of the hole.

25. The method of claim 17, in which
the choosing rule is that the patch having the highest similarity statistic is chosen.

26. The method of claim 17, in which
the similarity statistic is maximized when a difference statistic is a minimum, the difference statistic being the sum of the squared pixel data differences between the data of pixels surrounding the candidate patch, and the data of pixels surrounding the hole that correspond to the data of pixels surrounding the candidate patch according to their location relative to the patch.

27. The method of claim 17, further comprising:
adjusting the data of the pixels of the selected patch prior to rendering them.

28. The method of claim 27, in which
the adjusting is in view of the data of the pixels surrounding one of the selected patch and the hole.

29. The method of claim 17, in which
the pixels have another hole within them, and
further comprising:
selecting another one of the candidate patches of the pixels according to the matching criterion; and
rendering the data of the pixels of the other selected patch as the data of the other hole.

30. The method of claim 17, further comprising:
rendering the data of the pixels of the selected patch as the data of the patch.

31. The method of claim 17, in which
the selecting and rendering is performed on color data that has not been demosaiced.

32. A non-transitory computer-readable storage medium storing one or more programs, the one or more programs including instructions which, when executed by at least one imaging device a pixel array having pixels configured to generate data in response to exposure to an image, the pixel array having at least one hole within the pixels, they result in:
inputting the generated data;
selecting one of a plurality of candidate patches of the pixels, the selecting according to which one of the candidate patches has pixels surrounding it with data that best meet a choosing rule about a similarity statistic with the data of pixels surrounding the hole; and
rendering the data of the pixels of the selected patch as the data of the hole.

33. The medium of claim 32, in which executing the instructions further results in:
inputting coordinates for the hole; and
inputting coordinates for the pixels surrounding the hole.

34. The medium of claim 32, in which
the pixels surrounding the hole are adjacent to the hole.

35. The medium of claim 32, in which
the pixels surrounding the hole surround the hole completely.

36. The medium of claim 32, in which
the pixels are imaging pixels,
the hole includes one or more depth pixels, and
the pixels surrounding the hole are pixels that are 8-connected to any pixel belonging in the hole.

37. The medium of claim 32, in which executing the instructions further results in:
identifying the plurality of candidate patches.

38. The medium of claim 32, in which
the pixels are color pixels in a pattern of R, G, B, and
the candidate patches have a color order that is the same as a color order that would be defined by the pattern for the hole.

39. The medium of claim 32, in which
the patch has a size that is the same as a size of the hole.

40. The medium of claim 32, in which
the choosing rule is that the patch having the highest similarity statistic is chosen.

41. The medium of claim 32, in which
the similarity statistic is maximized when a difference statistic is a minimum, the difference statistic being the sum of the squared pixel data differences between the data of pixels surrounding the candidate patch, and the data of pixels surrounding the hole that correspond to the data of pixels surrounding the candidate patch according to their location relative to the patch.

42. The medium of claim 32, in which executing the instructions further results in:
adjusting the data of the pixels of the selected patch prior to rendering them.

43. The medium of claim 42, in which
the adjusting is in view of the data of the pixels surrounding one of the selected patch and the hole.

44. The medium of claim 32, in which
the pixels have another hole within them, and
further comprising:
selecting another one of the candidate patches of the pixels according to the matching criterion; and
rendering the data of the pixels of the other selected patch as the data of the other hole.

45. The medium of claim 32, in which executing the instructions further results in:
rendering the data of the pixels of the selected patch as the data of the patch.

46. The medium of claim 32, in which
the selecting and rendering is performed on color data that has not been demosaiced.
